(19) United States
(12) Patent Application Publication
(10) Pub. No.: US 2006/0004545 A1
(43) Pub. Date: Jan. 5, 2006

(54) Physical quantity sensor and apparatus for inspecting physical quantity sensor

(75) Inventor: Norifumi Souda, Oobu-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/169,625

(22) Filed: Jun. 30, 2005

(30) Foreign Application Priority Data
Jul. 1, 2004 (JP) 2004-195505

(51) Int. Cl. G06F 19/00

(52) U.S. Cl. 702/188

(57) ABSTRACT

The physical quantity sensor includes a sensing part sensing a physical quantity and generating sensor data representing a sensed physical quantity, a first communication part delivering the sensor data to a local area network in accordance with a predetermined communication protocol allowing a duplex communication, a second communication part delivering the sensor data to the local area network a synchronously, and a switching part selecting one of the first and second communication parts to be used for delivering the sensor data to the local area network.

### CROSS-REFERENCE TO RELATED APPLICATION

This application is related to Japanese Patent Application No. 2004-195505 filed on Jul. 1, 2004, the contents of which are hereby incorporated by reference.

### BACKGROUND OF THE INVENTION

1. Field of the Invention

The present invention relates to a physical quantity sensor capable of detecting a physical quantity such as pressure, acceleration and a yaw rate, and connectable to a LAN. The present invention also relates to an apparatus for inspecting such a physical quantity sensor.

2. Description of Related Art

Some physical quantity sensors include, in addition to a physical quantity sensing part, a sensor data output part having a microcomputer for processing sensor data, and a communication processor. Generally, to inspect whether or not physical quantity sensors function normally and exhibit intended performance under certain temperature and humidity conditions, a constant temperature bath is used.

It takes time for the temperature of a physical quantity sensor put in a constant temperature bath becomes stable at a set temperature in its entire part. Furthermore, in some cases, the set temperature is changed during inspection. Accordingly, it is common that a plurality of physical quantity sensors (for example, 50 to 100 physical quantity sensors) are put in the same constant temperature bath to inspect them at a time.

Incidentally, most of the recent personal computers are provided with a LAN interface so that they can communicate with other computers or information units in accordance with a certain communication protocol such as the TCP/IP.

Such a networking trend is not limited to personal computers. For example, it is known, as disclosed in Japanese Patent Application Laid-open No. 2003-244779, to use the CAN (Controller Area Network) as an in-vehicle LAN for the communication system between ECUs (vehicle-mounted Electronic Control Units), or between the ECUs and physical quantity sensors. The CAN, which was standardized as ISO11898, is used also in the field of FA (Factory Automation) by the designation of “DeviceNet”.

For such reason, the physical quantity sensors including a LAN interface as standard equipment are increasing in number. Also, the physical quantity sensors not provided with any analog voltage signal output function but including a LAN interface as the only communication means are increasing in number.

Generally, to inspect physical quantity sensors through their LAN interfaces, a personal computer-based LAN analyzer is used. It is also known to use a CAN communication diagnostic unit to inspect physical quantity sensors connectable to an in-vehicle LAN, as disclosed in Japanese Patent Application Laid-open No. 2003-244779.

It is possible to inspect a plurality of physical quantity sensors connected to the same LAN by use of only a single LAN analyzer at a time if they have different IDs or addresses, because the single LAN analyzer can identify any intended physical quantity sensor from others based on their IDs or addresses by performing the handshake with each one of the physical quantity sensors. However, in a case where all the physical quantity sensors are set to the same ID or address before shipment, it is not possible to inspect them at a time by use of a single inspection unit such as the LAN analyzer.

In such a case, it becomes necessary to use a plurality of inspection units (LAN analyzers), so that the plurality of the physical quantity sensors are connected to the plurality of the inspection units in a one-to-one relationship, or alternatively to use a selector switch for selecting one of a plurality of the LAN interfaces of the physical quantity sensors to be connected to a single inspection unit (LAN analyzer). This increases the inspection costs.

Incidentally, data packets (data frames) flowing on a LAN have a predetermined format designated by a communication protocol used (the TCP/IP, or CAN protocol, for example). However, although the data packets flowing on the same LAN have the same packet type (frame type), and the same internal field structure (that is, the same sequence and the same lengths of the internal fields), they may have user-specified portions. For example, the bit configuration of the ID field (or address field) of the data packet (data frame) is a user definable portion. Accordingly, there has been a problem in that the setting of the LAN analyzer(s) must be changed to meet the user definable portions of the data packets (data frames).

### SUMMARY OF THE INVENTION

The present invention provides a physical quantity sensor including:

a sensing part sensing a physical quantity and generating sensor data representing a sensed physical quantity;

a first communication part delivering the sensor data to a LAN in accordance with a predetermined communication protocol allowing a duplex communication;

a second communication part delivering the sensor data to the local area network a synchronously; and

a switching part selecting one of the first and second communication parts to be used for delivering the sensor data to the LAN.

The physical quantity sensor of the invention has both the capabilities of transmitting sensor data in accordance with a predetermined communication protocol allowing a duplex communication, and transmitting the sensor data a synchronously. Accordingly, the physical quantity sensor of the invention can send sensor data to any data processing unit, or ECU, or an inspection apparatus which supports a different communication protocol.

The present invention also provides an apparatus for inspecting physical quantity sensors including:

a selector switch including an output port, and a plurality of input ports connectable to a plurality of physical quantity sensors in a one-to-one relationship, the selector switch being configured to connect the output port to one of the plurality of the input ports selected in accordance with a selection command signal; and

a data processing unit supplying the selection command signal to the selector switch, and processing sensor data received from the output port of the selector switch in order to determine whether or not one of the plurality of the physical quantity sensors outputting the sensor data functions normally.

With the inspection apparatus of the invention, it becomes possible to inspect a plurality of physical quantity sensors at a time even when they have the same ID or address. Furthermore, it becomes unnecessary to change the setting of the inspection apparatus to meet user definable portions of data packets (data frames) forming sensor data, if the physical quantity sensors have capability of performing asynchronous data transmission.

### BRIEF DESCRIPTION OF THE DRAWINGS

In the accompanying drawings:

FIG. 1 is a block diagram showing a structure of a sensor unit according to a first embodiment of the invention set in a CAN transmit mode;

FIG. 2 is a timing diagram for explaining electrical characteristics of the physical layer of the CAN protocol in accordance with ISO11898;

FIG. 3 is a block diagram showing the structure of the sensor unit according to the first embodiment of the invention set in a serial transmit mode;

FIG. 4 is a flowchart showing a mode switching process between the CAN transmit mode and the serial transmit mode performed by a CPU included in the sensor unit according to the first embodiment of the invention;

FIG. 5 is a block diagram showing a structure of a sensor unit according to a second embodiment of the invention set in the CAN transmit mode;

FIG. 6 is a block diagram showing the structure of the sensor unit according to the second embodiment of the invention set in the serial transmit mode; and

FIG. 7 is a block diagram showing a structure of an inspection apparatus for inspecting the sensor units of the invention.

### PREFERRED EMBODIMENTS OF THE INVENTION

A sensor unit 20 according to a first embodiment of the invention is a physical quantity sensor mountable on a vehicle and capable of detecting a physical quantity such as acceleration, yaw rate, or impact acceleration of the vehicle. The sensor unit 20 is provided with a function of sending detected data to outer units such as ECUs through an in-vehicle LAN 100 which may be the CAN.

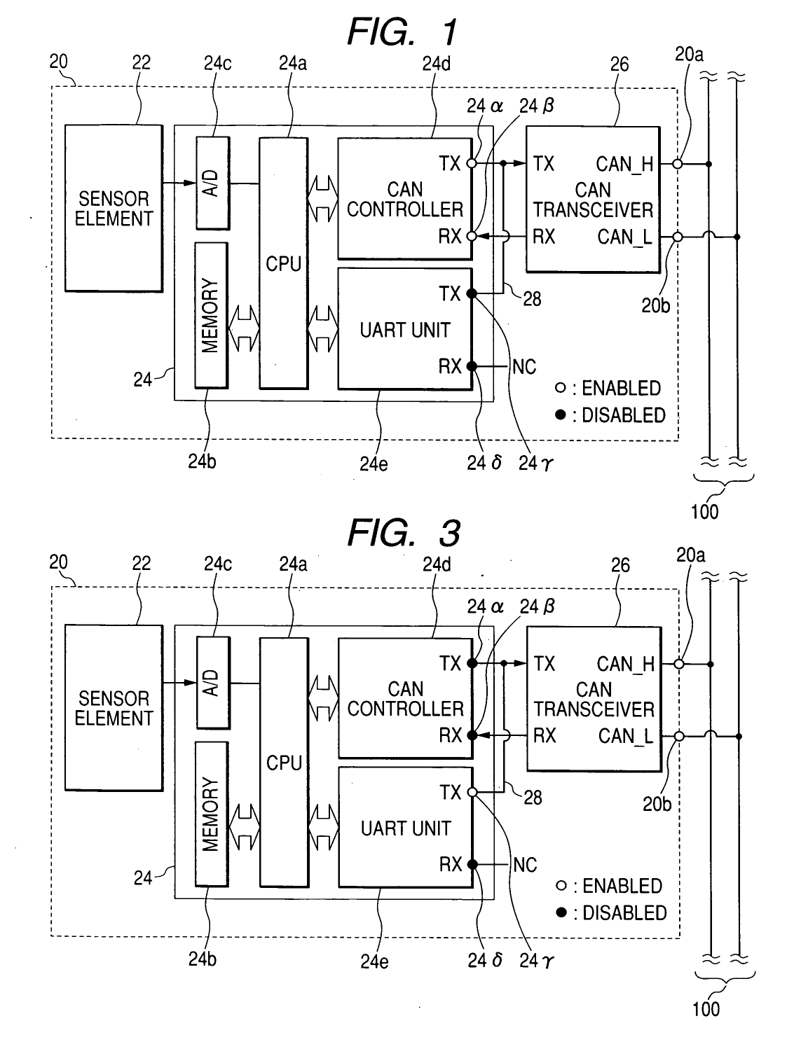

As shown in FIG. 1, the sensor unit 20 includes a sensor element 22, a microcomputer 24, and a CAN transceiver 26.

The sensor element 22 includes a bridge circuit which may be constituted, for example, by four bridge-connected piezo resistors and an operational amplifier which produces an analog sensor signal based on the current flowing through the bridge circuit.

The microcomputer 24, which is a one-chip microcomputer of the ASIC type, includes, other than a CPU 24a and a memory 24b, peripheral devices including an A/D converter 24c, a CAN controller 24d and a UART (Universal Asynchronous Receiver/Transmitter) unit 24e. The CPU 24a, which may be referred to as the MPU, includes a control unit, a program counter, an ALU, and a general-purpose register although they are not shown in FIG. 1. The memory 24b serving as a main memory of the CPU 24a includes a RAM which may be a DRAM or a SRAM, and a ROM which may be a PROM or an EEPROM. The memory 24b stores a control program and a communication mode switching program described later.

The A/D converter 24c is for converting the analog sensor signal received from the sensor element 22 into digital data by sampling this analog sensor signal at a certain sampling rate, and quantizing each sample into 8-bit data. The digital data outputted from the A/D converter 24c is supplied to the CPU 24a as sensor data.

The CAN controller 24d lying between the CPU 24a and the CAN transceiver 26 serves as a communication control unit enabling the CPU 24a to send and receive data through the data link layer and the transport layer of the CAN protocol. In the data link layer, reconfiguration into CAN data frames together with arbitration and error detection of a message constituted by the sensor data are carried out. In the transport layer, retransmission control is carried out as required. The CAN controller 24d has a CAN transmit port 24 a connected to a transmit port TX of the CAN transceiver 26, and a receive port 24 β connected to a receive port RX of the CAN transceiver 26. The CAN data frames produced by the CAN controller 24d are supplied to the CAN transceiver 26 through the CAN transmit port 24 α. On the other hand, CAN data frames coming from the in-vehicle LAN 100 side and received by the CAN transceiver 26 are supplied to the CAN controller 24d through the CAN receive port 24 β.

The UART unit 24e serving as a second communication control unit has a function of performing serial-to-parallel and parallel-to-serial conversions. The UART unit 24e delimits sensor data outputted from the CPU 24a into blocks having a certain number of bits (5 bits to 8 bits, for example), and adds a start bit, a stop bit and a parity bit to each block in order to form fixed-length transmit frames, thereby enabling a start-stop transmission (asynchronous serial transmission). That is, the UART unit 24e enables a serial transmission based on the simple bit synchronization, which does not require transmitting any synchronization signal separately.

The UART unit 24e has a transmit port 24 γ and a receive port 24 δ. The serial transmit port 24 γ is connected to the transmit port TX of the CAN transceiver 26 by a signal wire28 so that the transmit frames produced by the UART unit 24e are supplied to the CAN transceiver 26, and delivered to the in-vehicle LAN 100 through the physical layer of the CAN transceiver 26.

Since the signal wire 28 also connects the CAN transmit port 24a of the CAN controller 24d to the serial transmit port 24 γ of the UART unit 24e, there is a possibility of collision or wraparound between the transmit data produced by the CAN controller 24d and the transmit data produced by the UART unit 24e. Accordingly, in this embodiment, the CPU 24a controls the settings of these transmit ports to avoid the collision or wraparound between these transmit data by executing the control program. In this embodiment, the receive port 24 δ of the UART unit 24e is unconnected.

The CAN transceiver 26, which lies between the CAN controller 24d and the in-vehicle LAN 100 including a CAN bus constituted by CAN_H line and CAN_L line, is in conformity with ISO11898, and has the differential transmit capability to the in-vehicle LAN 100 and the differential receive capability to the CAN controller 24d. The CAN transceiver 26 has CAN_H and CAN_L terminals. The CAN_H and CAN_L terminals are connected to the in-vehicle LAN 100 through communication ports 20a, 20b of the sensor unit 20. The sensor unit 20 can communicate with CAN nodes (ECUs or other sensor units) connected to this in-vehicle LAN 100 through the communication ports 20a, 20b.

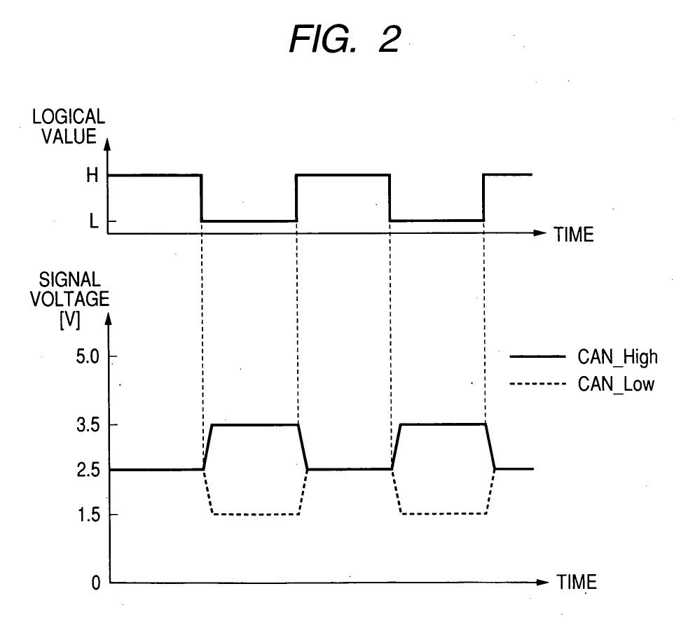

Here, the electrical characteristics of the physical layer of the CAN protocol in accordance with ISO11898 are explained below with reference to FIG. 2. As shown in FIG. 2, the physical layer of the CAN protocol is defined to output a voltage of +2.5V to both the CAN_H line and the CAN_L line when it receives a logical “H” level, whereas to output a voltage of +3.5V to the CAN_H line and a voltage of +1.5V to the CAN_L line when it receives a logical “L” level.

Hence, the CAN transceiver 26 produces the voltage of 2.5V at the CAN_H and CAN_L terminals when the transmit data received at the transmit port thereof shows the logical “H” level, thereby setting the differential voltage between the CAN_H line and the CAN_L line at 0 volts, whereas produces the voltage of +3.5V at the CAN_H terminal and the voltage of +1.5V at the CAN_L terminal when the transmit data received at the transmit port thereof shows the logical “L” level, thereby setting the differential voltage between the CAN_H line and the CAN_L line at 2 volts. On the other hand, the CAN transceiver 26 outputs the logical “H” level to the CAN controller 24d when it receives the voltage of 2.5V at both the CAN_H and CAN_L terminals, whereas outputs the logical “L” level to the CAN controller 24d when it receives the voltage of 3.5V at the CAN_H terminal and the voltage of 1.5V at the CAN_L terminal. The data communication by the physical layer of the CAN protocol has high noise immunity, because bit data is transmitted in the form of the differential voltage between two lines constituting the CAN bus.

Although not shown in FIG. 1, the CAN_H and CAN_L lines are connected with each other through 120-ohm terminator resistors at both ends of the CAN bus.

Incidentally, when the CAN protocol used is in conformity with ISO11519 and not with ISO11898, the electrical characteristics of the physical layer are somewhat different from those shown in FIG. 2, however they are the same in the way of using the differential voltage.

The mode where the CAN controller 24d loads the CAN frames with the sensor data supplied from the CPU 24a, and the CAN transceiver 26 delivers the CAN frames to the CAN bus is referred to as “CAN transmit mode” hereinafter. Likewise, the mode where the UART unit 24e converts the sensor data supplied from the CPU 24a into serial data blocks, and the CAN transceiver 26 delivers the serial data blocks to the CAN bus through the physical layer thereof is referred to as “serial transmit mode” hereinafter.

Below is an explanation about a switching control between the CAN transmit mode and the serial transmit mode.

As explained above, in the CAN transmit mode, the CAN controller 24d operates at the level of the data link layer of the CAN protocol to load the CAN frames with the sensor data supplied from the CPU 24a, and the CAN transceiver 26 delivers the CAN frames to the in-vehicle LAN 100 (CAN bus). Also in the CAN transmit mode, the CAN transceiver 26 receives CAN frames from the CAN bus, and the CAN controller 24d analyzes the received CAN frames and supplies them to the CPU 24a.

As understood from the above explanation, in the CAN transmit mode, the sensor unit 20 communicates with the ECUs or personal computers connected to the same in-vehicle LAN in accordance with the CAN protocol. The sensor unit 20 is in the CAN transmit mode when it is shipped from factory and mounted on a vehicle.

The UART unit 24e is not used in the CAN transmit mode. Accordingly, in the CAN transmit mode, the CPU 24a sets the serial transmit port 24 γ and the serial receive port 24 δ of the UART unit 24e at the disabled state as indicated by black circles in FIG. 1. On the other hand, in the CAN transmit mode, the CPU 24a sets the CAN transmit port 24 α and the CAN receive port 24 δ of the CAN controller 24d at the enabled state as indicated by white circles in FIG. 1.

With these settings, the UART unit 24e can be avoided from being affected by the CAN frames which go out of the CAN transmit port 24 α of the CAN controller 24d and reaches the serial transmit port of the UART unit 24e by way of the signal wire 28, because the CAN frames reaching the serial transmit port of the UART unit 24e are prohibited from being used and are ignored by software processing (control program).

In the serial transmit mode, the UART unit 24e converts the sensor data supplied from the CPU 24a into serial data blocks, and the CAN transceiver 26 delivers the serial data blocks to the in-vehicle LAN 100 (CAN bus) through the physical layer thereof. Also in the serial transmit mode, the CAN transceiver 26 receives serial data blocks from the CAN bus, and the UART unit 24e analyzes the received serial data blocks, and supplies them to the CPU 24a.

As understood from the above explanation, in the serial transmit mode, the sensor unit 20 communicates with the ECUs or personal computers connected to the same in-vehicle LAN in accordance with the star-stop (asynchronous) communication protocol. The sensor unit 20 is in the serial transmit mode when it undergoes factory inspection before shipment.

The CAN controller 24d is not used in the serial transmit mode. Accordingly, in the serial transmit mode, the CPU 24a sets the CAN transmit port 24a and the CAN receive port 24 β of the CAN controller 24d at the disabled state as indicated by black circles in FIG. 3. On the other hand, in the serial transmit mode, the CPU 24a sets the serial transmit port 24 γ of the UART unit 24e at the enabled state as indicated by a white circle in FIG. 3. The serial receive port 24 δ of the UART unit 24e is set at the disabled state even in the serial transmit mode, since the UART unit 24e is not used for receiving serial data in this embodiment.

With these settings, the CAN controller 24d unit 24e can be avoided from being affected by the serial data blocks which goes out of the serial transmit port 24 γ of the UART unit 24e and reaches the CAN transmit port 24 α of the CAN controller 24d by way of the signal wire 28, because the serial data blocks reaching the CAN transmit port 24 α are prohibited from being used and are ignored by software processing (control program).

Likewise, the CAN controller 24d unit 24e can be avoided from being affected by serial data blocks coming from the in-vehicle LAN 100 and reaching the CAN receive port 24 β through the CAN transceiver 26, because the serial data blocks reaching the CAN receive port 24 δ are prohibited from being used and are ignored by software processing (control program).

The settings of the CAN transmit port 24 α and CAN receive port 24 β of the CAN controller 24d, and the serial transmit port 24 γ and serial receive port 24 δ of the UART unit 24e are carried out by the CPU 24a which executes the control program for an initialization process in accordance with hardware-setting data supplied to the CPU 24a through control lines (not shown), or hardware information supplied to the CPU 24a through a hardware switch such as DIP switch assembly or short pins (not shown) Below is an explanation about the switching process between the CAN transmit mode and the serial transmit mode performed by the CPU 24a.

This mode switching process is carried out when the CPU 24a executes the communication mode switching program stored in the memory 24b. Here, it is assumed that the CPU 24a sets the sensor unit 20 at the CAN transmit mode at power-on or at restart, and that the in-vehicle LAN 100 supports the CAN protocol.

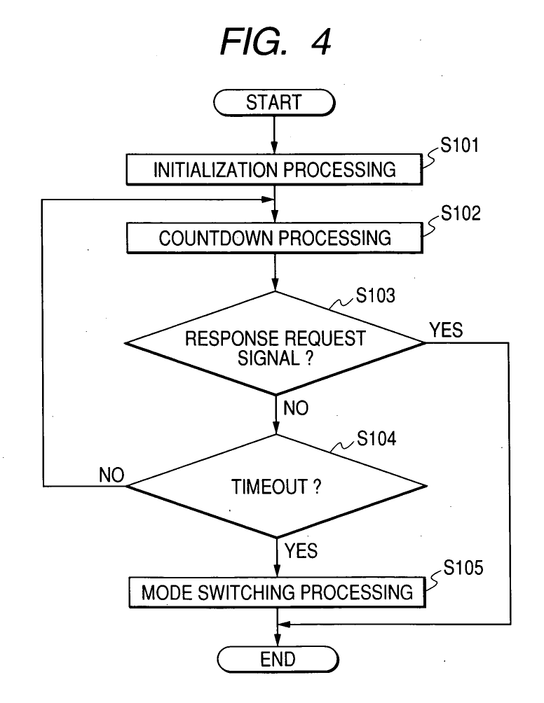

As shown in FIG. 4, in the mode switching process, an initialization processing is executed in the first place at step S101 where the capacity of a counter CNT (explained later) is set at an initial value (equivalent to a period of 30 seconds, for example).

Subsequently, a countdown processing where the count value of the counter CNT is decremented by one is executed at step S102.

Next, it is checked at step S103 whether or not any response request signal originating from any of other nodes connected to the in-vehicle LAN has been received. If the check result at step S103 is affirmative (“YES”), the CPU 24a recognizes that the sensor unit 20 is connected to any in-vehicle LAN supporting the CAN protocol, and terminates this mode switching process while keeping the sensor unit in the CAN transmit mode.

On the other hand, if the check result at step S103 is negative (“NO”), the CPU 24a recognizes that the sensor unit 20 is not connected to any in-vehicle LAN supporting the CAN protocol, and the process moves to step S104. At step S104, it is checked whether or not the count value of the counter CNT has been decremented to zero, that is, whether or not the timeout period of 30 seconds has elapsed. If the check result at step S104 is negative (“NO”), that is, if it is determined that the timeout period has not yet elapsed, then the process returns to step S102 to decrement the count value of the counter CNT.

On the other hand, if the check result at step S104 is affirmative (“YES”), then the process moves to step S105 to switch the sensor unit 20 from the CAN transmit mode to the serial transmit mode, because the sensor unit 20 can be regarded as not being connected to any in-vehicle LAN supporting the CAN protocol in a case where the sensor unit 20 has not received any response request signal over the timeout period. As a result of this mode switch, it becomes possible for the sensor unit 20 to transmit sensor data (serial data blocks) through the physical layer of the CAN transceiver 26.

As already described with reference to FIG. 3, to set the sensor unit 20 to the serial transmit mode, the CAN transmit port 24 α and the CAN receive port 24 β of the CAN controller 24d are disabled, and the serial transmit port 24 γ of the UART unit 24e is enabled.

As explained above, the sensor unit of this embodiment is configured to switch from the CAN transmit mode to the serial transmit mode if the sensor unit has received any response request signal from any of other nodes or ECUs within a predetermined timeout period. This configuration makes it possible to send sensor data through simplex serial data transmission to information processing units which do not support the CAN protocol.

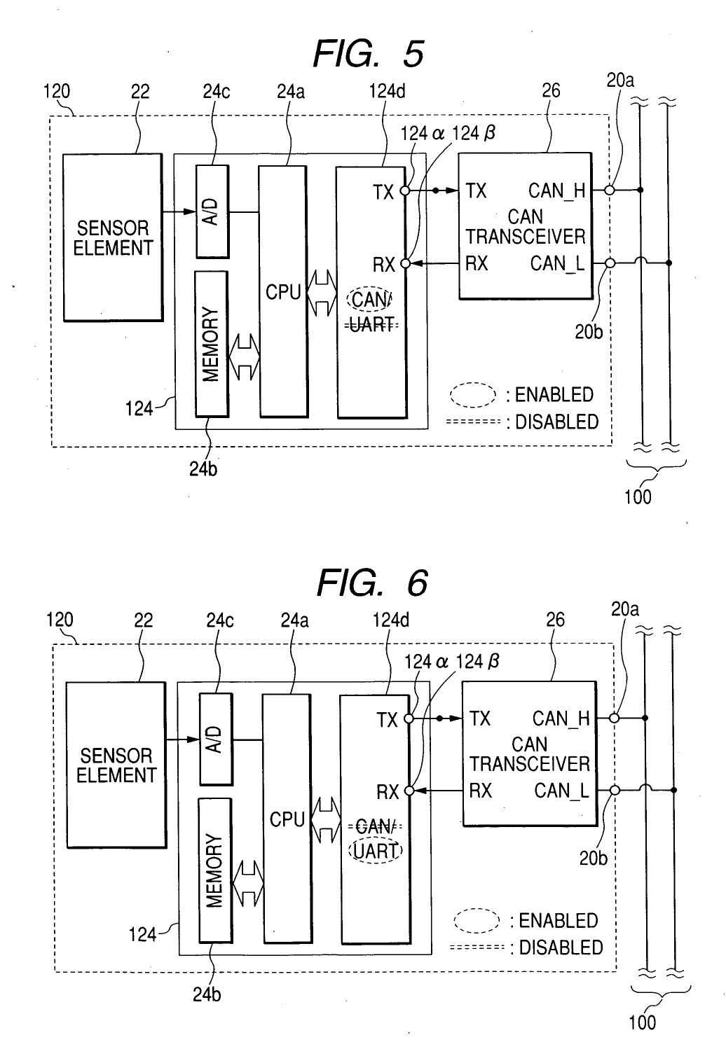

Although the sensor unit 20 is described as including the microcomputer 24 provided with the CAN controller 24d having the CAN transmit port 24 α and CAN receive port 24 β and the UART unit 24e having the serial transmit port 24 γ and serial receive port 24 δ, the invention should not be construed as being limited thereto. For example, the present invention is applicable to a sensor unit 120 that has a structure shown in FIG. 5. As shown in this figure, the sensor unit 120 as a physical quantity sensor according to a second embodiment of the invention has, instead of the microcomputer 24, a microcomputer 124 provided with a communication controller 124d which can function as the CAN controller and also the UART unit.

The communication controller 124d has a transmit port 124a serving as the CAN transmit port or the UART transmit port (serial transmit port), and a receive port 124 β serving as the CAN receive port or the UART receive port (serial receive port). The mode of the sensor unit 120 can be switched between the serial transmit mode and the CAN transmit mode by changing control programs to be executed by the CPU 24a.

When the sensor unit 120 is in the CAN transmit mode, the CAN controller function of communication controller 124d is enabled, and the UART function of the communication controller 124d is disabled as indicated in FIG. 5. As a result, the transmit data (CAN frames) outputted from the transmit port 124 α of the communication controller 124d operating as the CAN controller are delivered to the in-vehicle LAN 100 through the CAN transceiver 26. On the other hand, receive data (CAN frames) coming from the in-vehicle LAN 100 and received by the CAN transceiver 26 are inputted to the receive port 124 β of the communication controller 124d serving as the CAN controller.

When the sensor unit 120 is in the serial transmit mode, the CAN controller function of communication controller 124d is disabled, and the UART function of the communication controller 124d is enabled as indicated in FIG. 6. As a result, the serial transmit data (serial data blocks) outputted from the transmit port 124 α of the communication controller 124d operating as the UART unit are supplied to the CAN transceiver 26 and delivered to the in-vehicle LAN 100 through the physical layer of the CAN receiver 26. Although serial receive data (serial data blocks) coming through the in-vehicle LAN 100 and received by the CAN transceiver 26 are outputted to the receive port 124 β of the communication controller 124d operating as the UART unit, the sensor unit 124 is not affected by the serial receive data, because it is ignored by software processing (control program).

As explained above, the sensor units according to the first and second embodiments of the invention can transmit sensor data in accordance with a predetermined communication protocol allowing a duplex communication, or transmit sensor data a synchronously through a physical layer of the transceiver thereof allowing at least a simplex communication. Accordingly, the sensor units according to the first and second embodiments of the invention can send sensor data to any data processing unit, or ECU, or an inspection apparatus which supports a different communication protocol.

Although the sensor units and the in-vehicle LAN are described as supporting the ISO11898 or ISO11519 in the above described embodiments, the present invention should not be construed as being limited thereto. For example, the invention is applicable to sensor units supporting any wired LAN protocol such as the TCP/IP, IEEE802.1, LIN (Local Interconnect Network), FlexRay, TTP, MOST, IEEE1394, and USB.

Next, an inspection apparatus 10 for inspecting the sensor unit 20 or 120 is explained below.

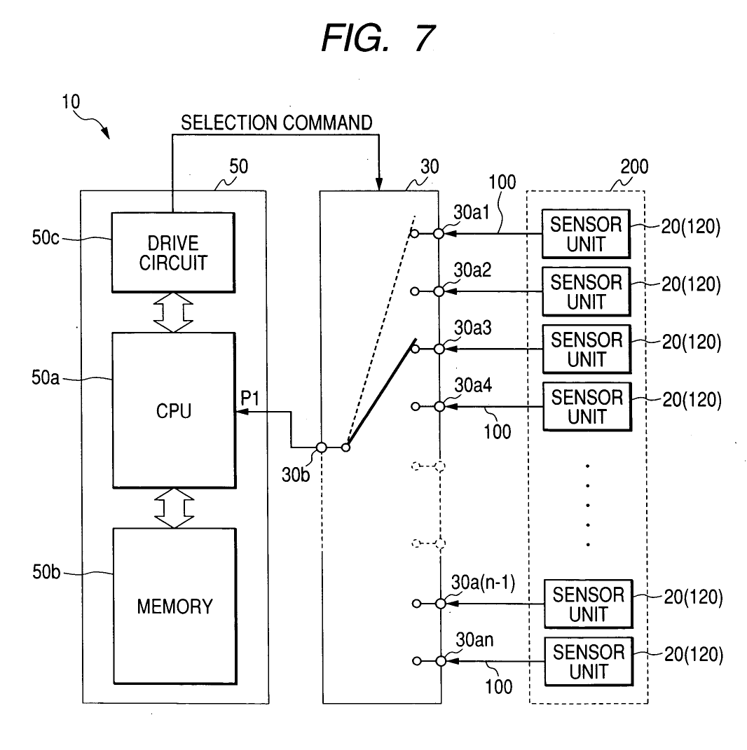

FIG. 7 is a block diagram showing a schematic structure of the inspection apparatus 10 capable of inspecting n (100, for example) sensor units 20 (120) put in a constant temperature bath 200 at a time.

As shown in FIG. 7, the inspection apparatus 10 includes a selector switch 30 and a personal computer 50. The selector switch 30 has an output port 30b, and a plurality of input ports 30a1 to 30an. The n input ports 30a1 to 30an are for receiving serial transmit data from the n sensor units 20 (120) as sensor data through the in-vehicle LAN 100 in a one-to-one relationship. The selector switch 30 is configured to select one of the input ports 30a1 to 30an in accordance with a selection command received from the personal computer 50, and forwards the sensor data being received by the selected one of the input ports 30a1 to 30an to the output port 30b. As a means for selecting one of the input ports 30a1 to 30an, a relay circuit of the electromagnetic type or semiconductor type may be used.

The personal computer 50 includes a CPU 50a having an input port P1 for receiving the sensor data from the selector switch 30, a memory 50b as a main memory thereof and a driver circuit 50c for generating the selection command. The personal computer 50 is configured to supply the selection command to the selector switch 30 and determine whether or not the sensor units 20 (120) are functioning normally on the basis of the sensor data received from the output port 30b of the selector switch 30. The memory 50b stores a control program, and an inspection program for inspecting the functions and performances of the sensor units 20 (120).

With this inspection apparatus having the above described structure, it becomes unnecessary to provide the personal computers 50 as many as the number of the sensor units 20 (120) to be inspected at a time even when all the sensor units 20 (120) have the same ID or address, because this inspection apparatus has capability of selecting any one of the plurality of the sensor units 20 (120).

The inspection apparatus 10 described above also can address the case where the sensor units 20 (120) have different IDs or addresses specific to their different destinations by changing setting of the personal computer 50.

The above explained preferred embodiments are exemplary of the invention of the present application which is described solely by the claims appended below. It should be understood that modifications of the preferred embodiments may be made as would occur to one of skill in the art.

What is claimed is:

1. A physical quantity sensor comprising:
a sensing part sensing a physical quantity and generating sensor data representing a sensed physical quantity;
a first communication part delivering said sensor data to a local area network in accordance with a predetermined communication protocol allowing a duplex communication;
a second communication part delivering said sensor data to said local area network a synchronously; and
a switching part selecting one of said first and second communication parts to be used for delivering said sensor data to said local area network.

2. The physical quantity sensor according to claim 1, wherein said second communication part delivers said sensor data to said local area network thorough a physical layer of said predetermined communication protocol, said physical layer allowing at least a simplex communication.

3. The physical quantity sensor according to claim 1, wherein said switching part is configured to make a switch from said first communication part to said second communication part when said first communication part does not receive any response request signal from said local area network over a predetermined time period.

4. The physical quantity sensor according to claim 1, further comprising a hardware switch for allowing selecting said second communication part when said physical quantity sensor is inspected.

5. The physical quantity sensor according to claim 1, wherein said predetermined communication protocol is in conformity with ISO11898 or ISO11519.

6. The physical quantity sensor according to claim 1, wherein said second communication part is configured to delimit sensor data into serial data blocks having a certain number of bits.

7. The physical quantity sensor according to claim 6, wherein said second communication part is configured to add a start bit, a stop bit and a parity bit to each of said serial data blocks in order to form fixed-length transmit frames, thereby enabling an asynchronous serial transmission.

8. A physical quantity sensor inspection apparatus comprising:
a selector switch including an output port, and a plurality of input ports connectable to a plurality of physical quantity sensors in a one-to-one relationship, said selector switch being configured to connect said output port to one of said plurality of said input ports selected in accordance with a selection command signal; and
a data processing unit supplying said selection command signal to said selector switch, and processing sensor data received from said output port of said selector switch in order to determine whether or not one of said plurality of said physical quantity sensors outputting said sensor data functions normally.
